(19) United States
(12) Patent Application Publication
(10) Pub. No.: US 2007/0100659 A1
(43) Pub. Date: May 3, 2007

(54) Management of clinical data exceptions in clinical information systems

(76) Inventor: Erik G. Preiss, Underhill, VT (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/261,333

(22) Filed: Oct. 27, 2005

(51) Int. Cl. G06Q 10/00; G06F 7/00

(52) U.S. Cl. 705/2; 707/7

(57) ABSTRACT

A clinical data exception management system receives clinical messages from a third party system, applies data validation rules to perform validation of various components of the received clinical messages, and stores the invalidated message and a rule (or rules) that invalidated the message. The system then resolves an exception and performs validation of the original message. As a result, the system captures important clinical information rather than requiring the third party system to retransmit the message.

### BACKGROUND OF THE INVENTION

1. Field of the Invention

This invention pertains in general to the field of clinical data management, and more particularly, to the management of clinical data exceptions in a medical information system.

2. Description of the Related Art

It is commonplace for clinicians to use clinical information systems that receive clinical messages from various third party medical systems. A receiving clinical system usually maintains a set of rules for accepting clinical messages. In the event a sending system violates at least one of the rules established by the receiving system, the receiving system rejects the message and does not file the received clinical data into a data repository. If the rejected message contains important clinical information about a patient that is different from the data that is currently stored in the receiving system, then a user of the receiving system may act upon incorrect data. For example, a hemodynamic system sends to a medical information system a message containing results of a procedure performed on a patient. A receiving system requires that sending data includes a patient identifier. If the received data does not include a patient identifier, then the message will typically be rejected. This may result in delayed patient care.

To address the existing problem of rejecting clinical messages, several software solutions have been developed in the area of medical imaging to capture those medical images that violate validation rules maintained by the receiving clinical system. According to these solutions, any set of images that arrives at the receiving system that cannot be reconciled with patients and/or exams in the receiving system is treated as a “broken” study. The receiving system fixes these “broken” studies by either matching a study to a patient and exam that already exists in a database of the receiving system or by manually creating the patient and exam record and then reconciling the study to the newly created exam. However, none of the existing solutions address the problem of capturing non-image data that would have been otherwise rejected.

Thus, there is a need in the art for a mechanism that captures non-image clinical data notwithstanding the rules that the receiving system would normally enforce.

### SUMMARY

The above need is met by a clinical data exception management system that receives clinical messages from a third party system, performs validation of the received clinical messages by applying data validation rules, creates message exceptions for non-validated messages, and allows a user to resolve the exceptions. Such a system provides the ability to capture important clinical information regardless of the rules that the system would normally enforce and to resolve the exceptions rather than requiring the third party system to retransmit the messages.

In one embodiment, the clinical data exception management system executes various engines to perform the required functionality. These engines include a data validation engine, an exception resolution engine, a patient record display user interface, and a data store.

The data validation engine is adapted to receive a clinical message that includes message components and to invoke data validation rules to perform validation of the message components. If at least one message component violates at least one rule, the data validation engine creates a message exception record. The message exception record is populated with various components of the original non-validated message and is being stored in a non-validated portion of the data store. The message exception record includes, among other attributes, an original message and an indication of a rule (or rules) that invalidated the message.

If none of the message components violates at least one rule, the data validation engine persists the data into the validated portion of the data store. The data validation engine optionally translates data in the message into the format adapted by the system.

The patient record display user interface (UI) is adapted to receive a user's request to display patient data based on a search criteria, such as a patient name, a procedure, or a study, and to display patient data that match the user's input. The displayed data include both validated and non-validated clinical data. The UI allows a user to access an original non-validated message corresponding to the non-validated clinical data.

The exception resolution engine is adapted to display to a user an original message and a rule (or rules) that invalidated the message corresponding to the non-validated clinical data. The exception resolution engine is adapted to resolve the exception. Resolving the exception may include modifying the original message, creating a new patient record, or performing other functions as needed to resolve the exception.

One skilled in the art will readily recognize from the following discussion that alternative embodiments of the structures and methods illustrated herein may be employed without departing from the principles of the invention described herein.

### BRIEF DESCRIPTION OF THE DRAWINGS

FIG. 1 is a high-level diagram illustrating an environment in which the present invention operates.

FIG. 2 is a block diagram of the components of a clinical data exception management system.

FIG. 3 is exemplary data stored in a data store shown in FIG. 2.

FIG. 4 is an event diagram of a method for resolving clinical data exceptions according to an embodiment of the present invention.

FIG. 5 is an exemplary user interface displaying validated and non-validated clinical data.

The figures depict one embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

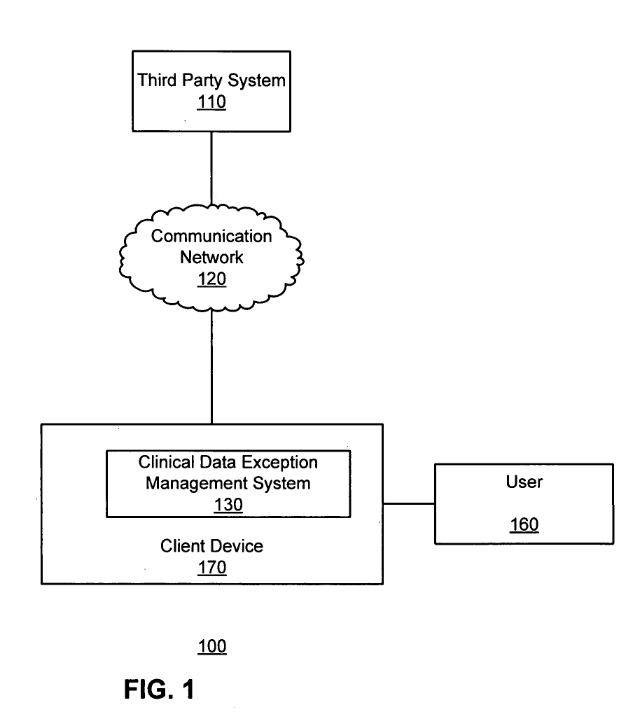

FIG. 1 is a block diagram of the environment in which one embodiment of the present invention operates. Environment 100 includes a clinical data exception management system 130 in communication with a third party system 110 over communication network 120.

Third party system 110 is a system adapted to communicate clinical data in the form of messages to clinical data exception management system 130. System 110 can be an information medical system, a hemodynamic system, or any other system capable of sending clinical data. Clinical data may include clinical results and other patient-related communication. For purposes of this invention, clinical data are also referred to as “patient data” or “medical data.” As used herein, “results” are findings ascertained during the performance of a medical procedure. Clinical messages are sent using standard mechanisms and message formats for electronic transmission of data, such as Health Level 7 (HL7), Digital Imaging and Communications in Medicine (DICOM) format, and other acceptable formats. Communication network 120 can be the hospital network or the Internet, and particularly, the World Wide Web portion thereof.

Clinical data exception management system 130 is adapted to receive messages from the third party system 110, apply data validation rules to validate data in the received messages, identify non-validated data, and create a message exception record for the non-validated data. The message exception record includes, among other components, an original invalid message and a rule (or rules) that invalidated the message. System 130 is further adapted to allow a user to access the original message and a rule that invalidated the message and to resolve the exception. In one implementation, resolving the exception includes modifying the original message. If the modified clinical message is validated, the validated data is persisted to a validated data portion of data store 250. In another embodiments, resolving the exception includes creating a new patient record or perform other functionality as needed. A person of ordinary skill in the art would understand that system 130 may invoke various architectural components to resolve the exception.

System 130 operates in several different modes according to the various embodiments and depending on the conditions and needs of a given healthcare information setting. In one embodiment, system 130 operates as a standalone system. When system 130 is implemented as a standalone system, system 130 is executed on a client device 170. The client device 170 can be a personal computer that includes a processor, an addressable memory, and other conventional features (not illustrated) such as a display, local memory, input/output ports, and a network interface. The client device 170 executes a web browser (not shown) for interpreting HTML or other display instructions in a web page and displaying the content accordingly to a user 160. Because the invention is described in the medical context, a user 160 of system 130 can be a physician, office administrator, and other medical staff member having access to system 130. Although one user 160 is shown in FIG. 1 for simplicity only, a person of ordinary skill in the art would understand that any number of permissible users can access system 130.

In another embodiment, system 130 is a client/server or web-based system executed on a server. When system 130 is implemented as a client/server system executed on a server, a user 160 of system 130 accesses system 130 over a communication network, such as the Internet, and particularly, the World Wide Web portion thereof, or any other communication mechanism that is capable of supporting communication between a user 160 and clinical data exception management system 130. In yet another embodiment, system 130 is integrated into a third party system or framework (not shown in FIG. 1) or a third party portal.

Clinical Data Exception Management System

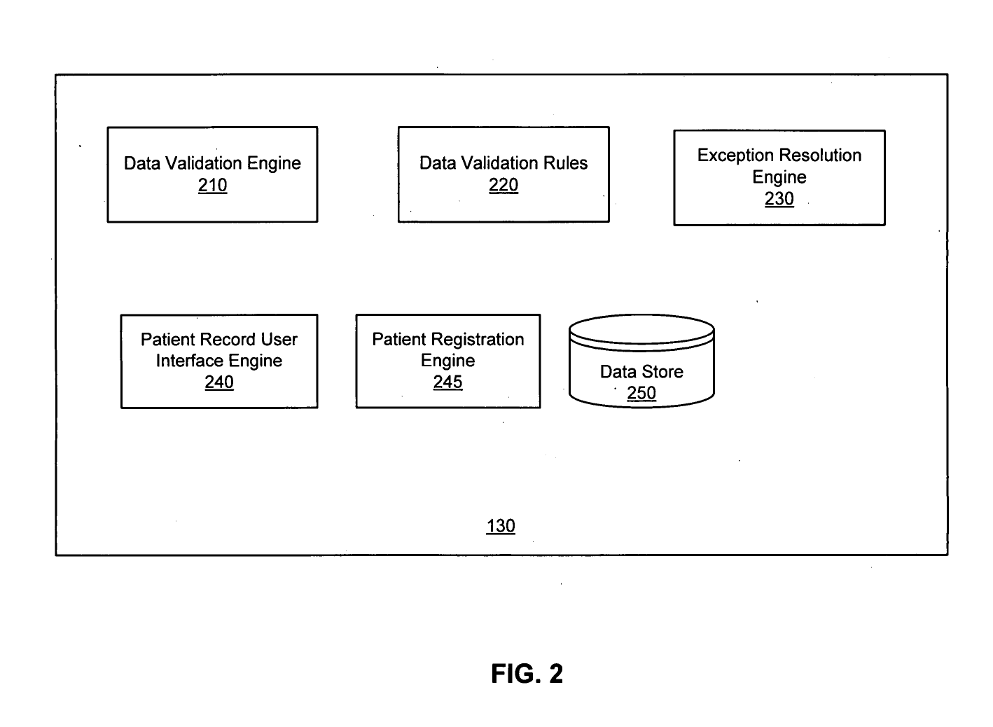

Turning now to FIG. 2, clinical data exception management system 130 includes various engines to perform the functionality of receiving a clinical message, validating the message, creating a message exception record if the message is not validated, and resolving the exception. These engines include a data validation engine 210, data validation rules 220, an exception resolution engine 230, a patient record user interface (UI) engine 240, a patient registration engine 245, and a data store 250. In one embodiment, these engines are implemented as modules. As used herein, the term “module” refers to computer program code adapted to provide the functionality attributed to the module. The program code is embodied in a random access memory (RAM), a read-only memory (ROM), or other media.

Data validation engine 210 is adapted to receive a clinical message and invoke data validation rules 220 to perform validation of the message. Data validation engine 210 is adapted to process the data validation rules 220 in a list form, checking messages against the rules in order, until the message is validated or not validated. If all data in the message match all the rules 220, then the data are persisted into a validated data portion of data store 250. For purposes of this invention, these data are referred to as “validated data” or “valid data.”

If at least one message component does not match at least one data validation rule 220, data validation engine 210 is adapted to persist these data into a non-validated data portion of data store 250. For purposes of this invention, these data are referred to as “non-valid data” or “non-validated data.” Data validation engine 210 also provides a rule (or rules) that invalidated the message and stores the rule in the non-validated data portion of data store 250.

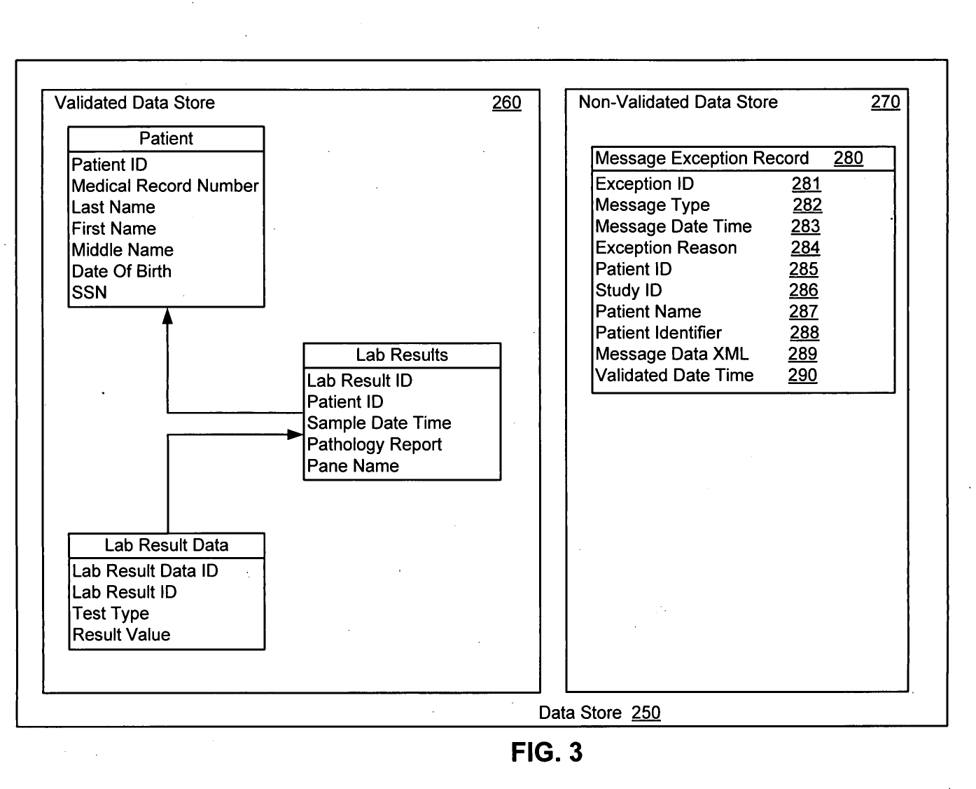

Data store 250 maintains data utilized by clinical data exception management engine 130 to perform its functionality. Turning now to FIG. 3, in one implementation, data store 250 maintains a validated data portion 260 and a non-validated data portion 270. Validated data portion 260 stores validated data, e.g., clinical data that match all data validation rules 220. Non-validated data portion 270 stores non-validated data, e.g., clinical data that do not match at least one validation rule 220. A person of ordinary skill in the art would understand that segmentation of validated and non-validated data can be accomplished using various mechanisms, such as attaching an indicator showing whether clinical data is validated, storing clinical data in more than one data store, or storing validated and non-validated data in different tables in data store 250.

Validated portion 260 of data store 250 stores patient clinical data in the form of patient records. A patient record contains fields for storing data associated with a patient. A field can hold data in the form of numeric, textual, binary information, and any other data type adapted for storage in a data store 250. In one embodiment and as shown in FIG. 3, a patient record includes patient identification information, such as patient ID, patient last name and first name, Social Security Number (SSN), date of birth, gender, medical record number, as well as clinical results. Clinical results may include lab results, such as a panel name, lab result ID, sample date/time, pathology report, and other clinical information.

The non-validated data portion 270 of the data store 250 maintains message exceptions records 280 generated by data validation engine 210 when a message received from third party system 110 does not match at least one validation rule. An exemplary message exception record 280 includes the following fields: exception ID 281, message type 282, message date/time 283, exception reason 284, patient ID 285, study ID 286, patient name 287, patient identifier 288 message data extensible markup language (XML) 289, and validated date/time 290. These fields are described in greater detail in a methods of operations section of this disclosure.

Data store 250 can be implemented, for example, as a relational database management system (RDMBS). Queries to the data store are accomplished via the Structured Query Language (SQL).

Patient registration engine 245 is adapted to register new patients by creating a new patient record in a validated data portion 260 of data store 250.

Referring again to FIG. 2, clinical data exception management system 130 further executes exception resolution engine 230 and patient record display UI engine 240. Engine 240 is adapted to receive a user input to view clinical data based on, for example, a patient name, study/procedure, and/or a group of studies/procedures, and to display clinical data (both validated and non-validated) from data store 250 that matches the user input.

Exception resolution engine 230 is adapted to display to a user an original clinical message associated with non-validated data and a rule (or rules) that invalidated the message. Engine 230 is further adapted to resolve the exception. Resolving the exception may include allowing a user to modify the original message, creating a new patient record, or performing other functions as needed. Engine 230 is further adapted to receive a user's modifications to the original message, to perform validation of the modified message, and to persist the validated modified message to the validated data portion 260 of data store 250. Exception resolution engine 230 is further adapted to utilize other components of system 130 to resolve the exception.

Exemplary Methods of Operation

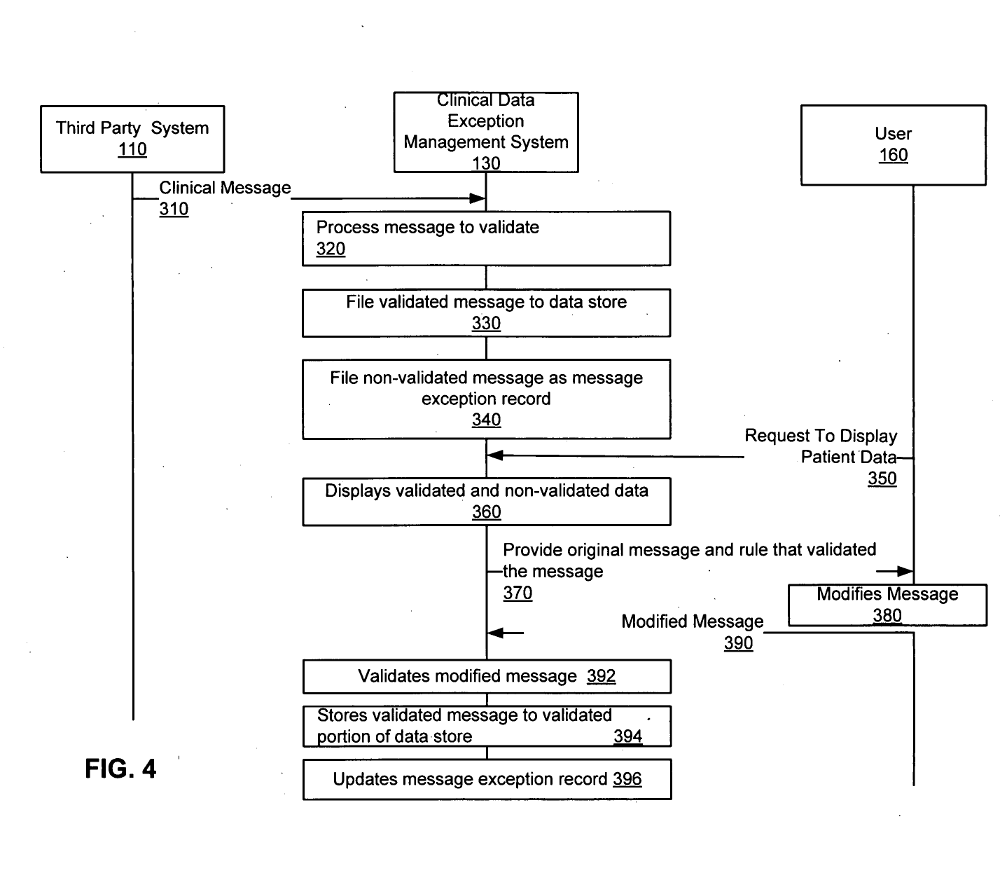

FIG. 4 is an event diagram illustrating exemplary transactions among third party system 110, clinical data exception management system 130 and a user 160. Beneath each entity is a vertical line representing the passage of time. The horizontal arrows between the vertical lines represent transactions between the associated entities. It should be noted that not every transaction is shown in FIG. 4. In other embodiments of the present invention, the order of the transactions can vary.

Initially, third party system 110 sends a clinical message 310 to clinical data exception management system 130. Clinical messages are sent using standard mechanisms and message formats for electronic transmission of data, such as HL7, DICOM, and other formats acceptable for sending clinical messages. The message may include, for example, clinical results and other patient-related data. “Clinical results” refer to findings ascertained during the performance of a medical procedure performed on a patient. A clinical message may include a plurality of message components, such as a patient name, a patient ID, a medial record number (MRN), date of birth, a pathology report, a lab result ID, a result value, and other clinical data.

System 130 receives the clinical message and performs 320 validation of the message components. As part of the validation process, system 130 invokes data validation rules 220 and processes the rules in a list form, checking all the message components against the rules in order, until the message is validated or not validated. Exemplary validation rules applied by system 130 are shown below in Table 1. A person of ordinary skill in the art would understand that the set of rules listed below is not exhaustive.

TABLE 1
Data Validation Rules

| Rule | |
|---|---|
| No. | Rule |
| 1 | Patient Medical Record Number (MRN) must match |
| | MRN stored |
| 2 | Accession number and patient MRN must match a |
| | patient MRN/Accession number stored |
| 3 | Physician ID number must match a physician ID |
| | number stored |
| 4 | Patient last name cannot exceed 20 characters |
| 5 | Patient last name cannot have hyphens |

If all of the components of the clinical message do not violate any of the data validation rules enforced by system 130, the message is deemed to be validated. In one implementation, system 130 translates the message components into the format maintained by data store 250 and persists 330 the translated data into validated data portion 260. For example, if the data from third party system 110 represents gender as an integer value (e.g., 0=male, 1=female, 2=unknown) and system 130 represents gender as an alphanumeric character (e.g., m=male, f=female, u=unknown), data validation engine 210 translates the data from the first format to the second format.

If at least one component of the clinical message violates one or more data validation rules, data validation engine 210 extracts various components of the message, such as message date/time, patient ID, and study ID, populates a message exception record with these and other data, and stores 340 the message exception record in non-validated data portion 270 of data store 250. Data validation engine 210 also stores a rule (or rules) that invalidated the message in the message exception record 280.

Referring again to FIG. 3, an exemplary format of message exception record 280 is shown. A person of ordinary skill in the art would understand that a number of message exception records stored in data store 250 may correspond to the number of invalidated clinical messages. In one implementation, message exception record 280 includes the following fields:

Exception ID field 281 stores a sequential number generated by system 130 uniquely identifying a message exception record 280;

Message type field 282 stores a type of the message, e.g., lab result;

Message date/time field 283 stores a time stamp indicating date and time when the message was received;

Exception reason field 284 stores a data validation rule (or rules) that invalidated the message. It should be noted that exception reason field 284 may include any number of rules as more than one rule may invalidate the message.

Patient ID field 285, study ID field 286, and patient identifier field 287 are populated with the patient ID, study ID, and patient identifier, respectively, included in the message. If any of these fields are empty in the message, these fields remain empty in message exception record 280.

Message data XML field 289 stores an original message received by system 130 in an Extensible Markup Language (XML) format. It should be noted that an original clinical message may be stored in any other format acceptable by system 130.

Validated date/time field 290 stores a time stamp indicating when the original message was modified by a user 160.

Referring again to FIG. 4, a user 160 of system 130 requests 350 to view clinical data. For example, a user 160 may request to view a patient record, a group of patient records, study/procedure and/or a group of studies and procedures. Patient record display UI 240 queries patient data in both validated data portion 260 and non-validated data portion 270 of data store 250 using, for example, a patient name and/or patient MRN, study ID, or any other parameter. Patient record display UI 240 searches both validated data portion 260 and non-validated data 270 of data store 250 for patient data that matches the request and displays matching patient data with an indication of whether the displayed patient data is validated or not. In one implementation, patient record display UI 240 displays non-validated data differently than the validated data. In one implementation, an indicator, such as an icon may be placed next to non-validated data. In another implementation, non-validated data can be of a different color than the validated data. In yet another implementation, specific audio tones can be used to indicate that the data is not validated. A person of ordinary skill in the art would understand that various mechanisms may be used to display non-validated data. To ensure that only non-modified non-validated data is displayed, patient record display UI 240 queries only for non-validated data having validated date/time field 290 empty in the message exception record.

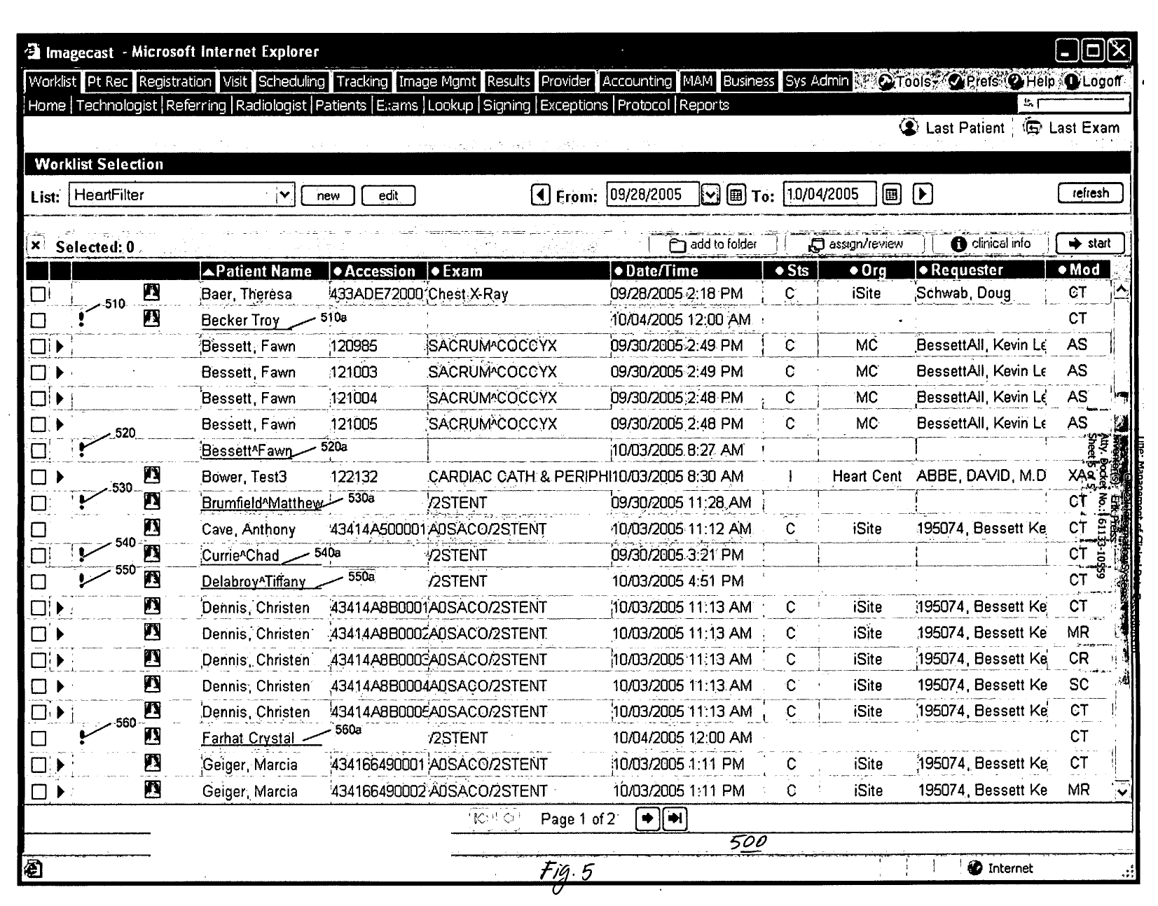

Turning now to FIG. 5, an exemplary user interface 500 provided to user 160 is shown. The exemplary user interface 500 displays patient data requested by a user 160 of system 130. The displayed data may be validated and non-validated. For example, records identified by legend numbers 510, 520, 530, 540, 550 and 560 include non-validated data. These records are marked as non-validated using exclamation points placed at the beginning of records 510, 520, 530, 540, 550, and 560. Records identified by legend numbers 520, 530, 540, and 550 include patient data that is not-validated because patient name field in each of these records violates a rule that requires that a patient name cannot include character “ˆ”. Records 510 and 560 include patient data that is not-validated because each of these records violates a rule that requires an accession number in the message. Records 520, 530, 540 and 550 include patient data that violate a similar rule. Placing an indicator next to a non-validated record alerts a user 160 that certain components of a record are not valid.

Still referring to FIG. 5, while a user 160 is reviewing validated and non-validated data, the user 160 may be able to access a user interface provided by exception resolution engine 230 that allows a user to modify various message components. A user may access the user interface of exception resolution engine 230 via various mechanisms, such as a hyperlink, a hot key, a button, or any other mechanism. For example, user 160 may click on hyperlink 540a below patient name “CurrierˆChad.” Exception resolution engine 230 accesses the message exception record 280 corresponding to the non-validated data and provides to a user 160 the original clinical message and a rule (or rules) that invalidated the message.

The user 160 reviews the displayed clinical message and the rule (or rules) that invalidated the message. The user 160 modifies 380 those message components that violated the data validation rules. Once the message components are modified and the user submits the message, the message is received by exception resolution engine 230. Exception resolution engine 230 performs validation 392 of the modified message. In one implementation, exception resolution engine 230 evaluates only modified message components against a data validation rule (or rules) that invalidated the message. In another implementation, exception resolution engine 230 evaluates all the components of the modified message against all data validation rules. Exception resolution engine 230 processes the rules in a list form, checking all the message components against the rules in order, until the message is validated or not validated.

If the modified message is validated, exception resolution engine 230 persists 394 validated data into validated data portion 260 of data store 250. In addition, exception resolution engine 230 updates 396 message exception record 280 in the non-validated data portion 270 of data store 250 to indicate that the message was validated. As part of this step, engine 230 updates validated date time field 290 of message exception record 280 with the time when the message was modified. As a result, the non-validated data that has been modified and validated is not going to be provided to a user 160. This advantageously prevents incorrect non-validated data from being presented to a user 160 after it was modified and validated.

The following example will illustrate the process illustrated above. Assuming a clinical message arrives with a patient name that includes an invalid character (e.g., “CurrierˆChad”). Data validation engine 210 evaluates all the components of the message against all the validation rules. As a result of the evaluation, the message will be invalidated based on the rule that the patient name cannot include invalid characters, such as “ˆ” Data validation engine 210 extracts a patient ID, a study ID, the date and time when the message was received, and a patient name and populates corresponding fields in a message exception record 280. Data validation engine 210 generates a message exception ID, populates exception reason field 284 with a rule that invalidated the message (e.g., patient name cannot include character “ˆ”), and stores the original message to message data XML field 289. For example, a user 160 requests system 130 to provide patient data based on patient name, e.g., Chad Currier. Patient record display UI 240 receives the request and searches data store 250 for patient data associated with Chad Currier. Patient record display UI 240 displays all patient data associated with Chad Currier. As shown in FIG. 5, non-validated data for Chad Currier is displayed differently than the validated data, e.g., an exclamation mark may be placed next to the non-validated data.

A user 160 may access an original message and modify various components of the message by clicking on a button, a hyperlink, or using other means of accessing a user interface of exception resolution engine 230. The UI will display the original message as well as a rule that invalidated the original message. A user 160 will be able to modify the patient name component of the original message to delete a non-valid character. Exception resolution engine 230 receives the modified message, evaluates the message against the data validation rules, and stores the modified message in the validated data portion 260 of data store 250. Exception resolution engine 230 updates message exception record 280 to indicate the time when the message was validated.

In another example, if a received message has a patient MRN that does not exist in data store 250, the message will be invalidated because it violates a rule that requires that a patient MRN in the message must match a patient MRN stored in system 130. As a result, an exception message record will be created for this message. When a user 160 sends a request to display patient data based on, for example, a study or procedure, patient data that includes the requested study or procedure associated with the invalidated message will be displayed. System 160 enables a user to access an original message and a rule that invalidated the message via exception resolution engine 230. A user 160 will be able to resolve the exception by, for example, creating a new patient record with a patient MRN included in the invalidated message. As part of this step, exception resolution engine 230 invokes patient registration engine 245 to create a new patient record in the validated data portion 260 of data store 250. Once a new patient record has been created with the MRN, exception resolution engine 230 applies data validation rules 220 to the invalidated message. As part of this process, exception resolution engine 230 determines whether the patient MRN in the original message matches a patient MRN stored in data store 250. Since a new patient record with the same patient MRN has just been created, exception resolution engine 230 validates the original message and updates the message exception record with the date and time when the exception was resolved.

Thus, the present invention advantageously captures clinical messages that violate at least one data validation rule, stores those messages as invalidated data, allows a user to view an original message and a rule that invalidated the message and to resolve the exception. As a result, the present invention captures important clinical patient information rather than requiring a third party system to retransmit a rejected message.

The present invention has been described with reference to several embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, product specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A method for validating a patient-related clinical message received by a clinical information system, the message including a plurality of data components, the method comprising:
applying data validation rules to the message components to validate the message;
responsive to at least one message component in the clinical message violating at least one data validation rule:
invalidating the message, and
storing the invalidated message in association with at least one rule that invalidated the message;
receiving a user input to display patient data;
providing, in response to the user input, the invalidated clinical message associated with the requested patient data and the at least one rule that invalidated the message;
receiving a user modifications to the components of the invalidated clinical message; and
applying the data validation rules to the modified message components to validate the message.

2. The method of claim 1, further comprising:
extracting message components from the invalidated clinical message;
generating a message exception record;
populating the message exception record with the extracted message components;
populating the message exception record with the at least one rule that invalidated the message; and
attaching the invalidated message to the message exception record.

3. The method of claim 1, wherein the message components in the received clinical message are in a first format and the system maintains data in a second format, the method further comprising:
translating the message components of the invalidated message from the first format to the second format.

4. The method of claim 1, further comprising providing an indication in the message exception record when the modified message was validated.

5. The method of claim 1, further comprising:
responsive to none of the message components in the clinical message violating validation rules:
extracting message components from the validated clinical message, and
storing the extracted message components as validated data.

6. The method of claim 1, further comprising:
providing, in response to the user input, requested patient data that includes validated and non-validated patient data; and
allowing the user to access the received clinical message associated with the non-validated patient data and the at least one rule that invalidated the received clinical message.

7. The method of claim 6, further comprising providing an indication that the displayed patient data includes non-validated data.

8. The method of claim 1, further comprising:
responsive to none of the message components in the modified clinical message violating data validation rules:
extracting message components from the modified clinical message, and
storing the extracted message components as validated data.

9. A system for validating a patient-related clinical message received by a clinical information system, the message including a plurality of data components, the system comprising:
a data validation engine adapted to:
apply data validation rules to the message components to validate the message, and
responsive to at least one message component in the clinical message violating at least one data validation rule, invalidate the message and store the non-validated message and the at least one rule that invalidated the message;
a data store adapted to store the non-validated message and the at least one rule that invalidated the message;
a record display user interface engine adapted to display patient data in response to a user request; and
an exception resolution engine adapted to provide to the user the invalidated clinical message associated with the requested patient data and the at least one rule that invalidated the message, to receive a user modification to the components of the invalidated clinical message, and to apply the data validation rules to the modified message components to validate the message.

10. The system of claim 9, wherein the data validation engine is further adapted to:
extract message components from the invalidated clinical message,
generate a message exception record,
populate the message exception record with the extracted message components,
populate the message exception record with the at least one rule that invalidated the message, and
attach the invalidated message to the message exception record.

11. The system of claim 9, wherein the message components in the received clinical message are in a first format and the system maintains data in a second format, wherein the data validation engine is further adapted to:
translate the message components of the invalidated message from the first format to the second format.

12. The system of claim 9, wherein the exception resolution engine is further adapted to provide an indication in the message exception record when the modified message was validated.

13. The system of claim 9, wherein the data validation engine is further adapted to:
extract message components from the validated clinical message, and
store the extracted message components in the data store as validated data, responsive to none of the message components in the clinical message violating validation rules.

14. The system of claim 9, wherein the patient record user interface engine is further adapted to provide an indication that the displayed patient data includes non-validated data.

15. A computer program product comprising:
a computer-readable medium having computer program code embodied therein for validating a patient-related clinical message received by a clinical information system, the message including a plurality of data components, the computer program code adapted to:
apply data validation rules to the message components to validate the message;
responsive to at least one message component in the clinical message violating at least one data validation rule:
invalidate the message, and
store the invalidated message in association with at least one rule that invalidated the message;
receive a user input to display patient data;
provide, in response to the user input, the invalidated clinical message associated with the requested patient data and the at least one rule that invalidated the message;
receive a user modification to the components of the invalidated clinical message; and
apply the data validation rules to the modified message components to validate the message.
